(19) United States
(12) Patent Application Publication
(10) Pub. No.: US 2007/0139609 A1
(43) Pub. Date: Jun. 21, 2007

(54) DOWNHOLE TOOL

(76) Inventor: David L. Budney, Edmonton (CA)

Correspondence Address: LAW OFFICE OF MARC D. MACHTINGER, LTD., 750 W. LAKE COOK ROAD, SUITE 350, BUFFALO GROVE, IL, 60089, US

(21) Appl. No.: 11/306,065

(22) Filed: Dec. 15, 2005

(51) Int. Cl. G02C 7/02

(52) U.S. Cl. 351/159

(57) ABSTRACT

Non-prescription eyeglasses are disclosed. The eyeglasses include lenses having a region having increased convexity and magnification. The region is preferably centered below a horizontal on the lenses. Thus, a wedge shape is created. The thicker portion of the wedge is oriented toward the upper and inner side of the lenses, thus allowing the user to view close objects with decreased strain on the eyes. The method of providing non-prescription glasses having the features and advantages of the present invention without the need for a diagnosis or prescription is also disclosed.

### BACKGROUND OF THE INVENTION

The present invention relates to eyeglasses, and more specifically to non-prescription reading glasses combining lower magnification in the upper meridian and with optical centers up and in from a center point.

### DESCRIPTION OF THE RELATED ART

Modern reading glasses are said to have their origins in Benjamin Franklin's invention of bi-focal lenses. Many aspects of those original bi-focal lenses are still in use today. There have been numerous improvements and modifications to these early lenses. Of particular importance to the present invention are the use of lenses having no magnification in the upper meridian and having optical centers located upward and inward.

Lenses referred to herein as having “up and in” optical centers work according to the following principles. The lenses have a greater thickness near the user's nose and near the top of the nose when compared to the thickness of the lenses near the user's temple and the bottom edge of the lenses. This variation in thickness causes incoming light to bend toward the thicker edge as the light passes through the lens. By bending the light in this manner, the user's eye is able to remain in a more natural position. By remaining in a more natural position, strain on the eye, and thus strain on the user, is reduced. Reduced eye strain results in a more comfortable eyeglass wearing experience for the user.

Lenses having no magnification in the upper meridian work according to the following principles. The convexity of the lenses varies across the lens. This allows the user to look through different portions of the lens to see objects at various distances with greater clarity. Typically, the maximum convexity is located generally below the horizontal centerline of the lens, which allows a user's eye to achieve the natural position of looking slightly downward while reading. As mentioned above, by allowing the eye to achieve a natural position, eye strain is reduced.

An example of progressive lens technology is disclosed in U.S. Pat. No. 4,461,550, issued to Legendre. Legendre discloses a lens which has an upper part of constant refractive power for distance vision and a lower part of variable refractive power for near vision.

U.S. Pat. No. 5,270,745, issued to Pedrono, discloses a lens that has an aspherical surface have a zone for far vision, a zone for near vision, and between these two zones, a zone for intermediate vision, with a meridian curve along which the curvature of the surface varies progressively and which is inclined from top to bottom towards the nose side of the lens, at least in the intermediate zone. A portion of the meridian curve is situated in the intermediate and near zones is divided into a first segment at an angle α to the vertical where the value of α is an increasing function of the power addition A of the lens, and a second segment at an angle ω to the vertical where the value of ω is smaller than α. At the point where the two segments meet, the mean sphere value of the surface corresponds to a power addition lying in the range 0.8 to 0.92 time the nominal power addition of the lens.

U.S. Pat. No. 5,235,359, issued to Chauveau et al., discloses aspherical lenses and method of facilitating their manufacture. According to Chauveau, the front surface, for example, has a central area whose curvature varies over at least part of a least on meridian and constitutes its optically active area. Surrounding this central area is a peripheral joining area merging tangentially with it. The optically active central area of the front surface is delimited by a closed curve which, when projected onto a plane perpendicular to the geometrical axis of the lens, is generally oval shape. The value and/or sign of the radius of curvature of the radial cross-section of the peripheral joining area varies in the circumferential direction so that the thickness of the lens is substantially the same all along its peripheral edge.

While each of the types of lenses mentioned above may be useful for their intended purpose, lenses having the features or of the types mentioned above do not incorporate optical centers located up and in, and heretofore have required a prescription from a skilled eye care professional.

There remains a need for non-prescription reading glasses having the combined advantages of having substantially no magnification in the upper meridian and having optical centers located up and in. There also remains a need to provide such a combination of advantages to individuals without requiring a diagnosis and prescription by a professional. Thus, it would be advantageous to provide non-prescription eyeglasses combining the above discussed features.

### SUMMARY

In view of the deficiencies described above, it is an object of the present invention to provide non-prescription eyeglasses having various features and advantages.

The eyeglasses of the present invention take advantage of several improvements. First, the eyeglasses include lenses having no or substantially no magnification in the upper meridian, or less magnification in the upper meridian than in the lower meridian. This is accomplished by incorporating a region, preferably off-center below the horizontal, of increased convexity and magnification. This enables the user to view close objects through this region with greater magnification, and view objects farther away through a less convex area of the lens.

Preferably, the transition between the increased magnification region and the other portions of the lens is wide and substantially smooth to enable a smooth transition when viewing from near to far, or vice versa.

Furthermore, the eyeglasses of the present invention preferably include lenses having a contour which is wedge shaped. The thicker portion of the lens is oriented toward the inner side and upper side of the lens, and the thinner portion is oriented toward the outside and lower area of the lens. Thus, closer objects can be viewed with less eye strain. The combination of these two features produces an unexpectedly improved viewing experience.

The above features have not been made available to consumers without a diagnosis or prescription. However, the basic advantages of these features are applicable to a wide variety of individuals. Thus, it is advantageous to provide non-prescription reading glasses of the type described to general consumers without the need for a diagnosis or prescription from a professional.

Other features and advantages of the invention will be apparent from the following detailed description taken in conjunction with the following figures, wherein like reference numerals represent like features.

### BRIEF DESCRIPTION OF THE FIGURES

FIG. 1 is a perspective view of the eyeglasses of the present invention.

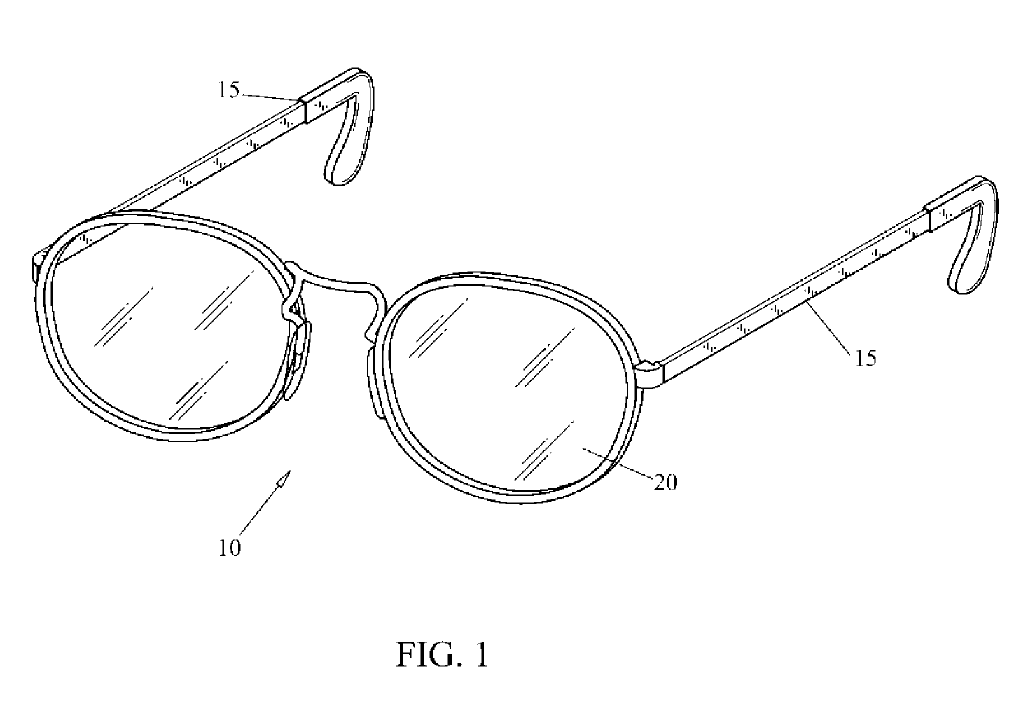

FIG. 2 is a top sectional view of a lens of the eyeglasses of the present invention.

FIG. 3 is a front view of a lens of the eyeglasses of the present invention.

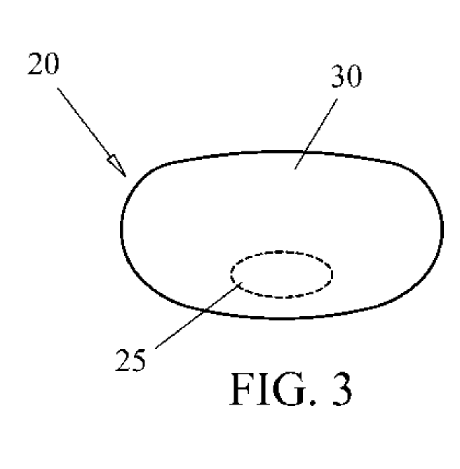

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

The present invention, in its various embodiments, is an improved set of reading eyeglasses 10. The eyeglasses 10 include frames 15 having two lenses 20 therein. The lenses 20 have various features and advantages previously not known in non-prescription reading glasses.

Each of the lenses 20 includes a de-centered region 25 having increased convexity, and thus, increased magnification. Thus, an individual can view near objects such as reading material through region 25 with magnification. Preferably, the contour of the lenses 20 incorporates a smooth transition between the de-centered region 25 and peripheral regions 30 of the lenses 20 such that there is a continuous transition in vision from the top area to the bottom area.

Vision through a lower portion of the lenses 20 incorporates a magnification factor to assist a user in near vision reading. However, vision through the center and upper portions 30 of the lenses 20 incorporates less magnification for farther vision.

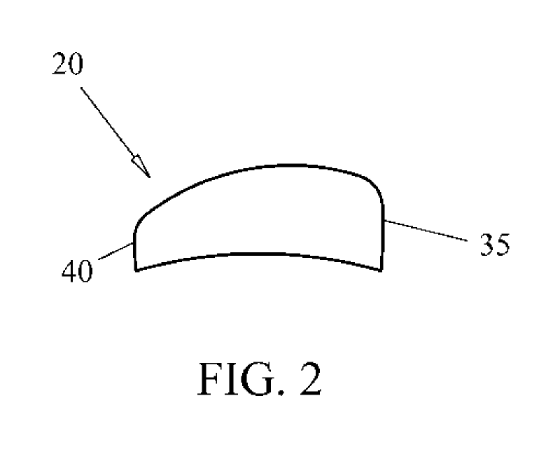

In various embodiments, the lenses 20 preferably conform to a wedge shape, as shown in FIG. 2. The contoured wedge is oriented such that a thicker portion 35 of the lenses 20 is disposed at the inner and upper side of the lenses 20. The inner and upper side of the lenses 20 is the side which is positioned closer to the nose and eyebrow when the glasses 10 are in use. The lens 20 gradually thins toward the bottom and outside portion 40, where the lens 20 is thinner.

The wedge shape preferably results in a convergence of light inward and upward which enables the user to focus on near objects with less strain. This is accomplished because a line of sight coming from a more central point is bent so that it enters the eye at an angle closer to a line straight out of the eye, which enables the user to view close objects without the need for the eyes to converge and gaze downward as far in their sockets as typically occurs when near objects are viewed.

The features of the present invention are most ideally combined such that the advantages of the wedge shape are combined with the smooth transition between de-centered region 25 and peripheral regions 30 of the lenses 20 in such a manner that there is a continuous transition in vision from the top to the bottom of the lens. Furthermore, the combined features ideally include a magnification factor to assist a user in near vision reading, and so that vision through the center and upper portions 30 of the lenses 20 incorporates less magnification for distant vision. Such a combination has not been available to individuals in non-prescription reading glasses.

The present invention also relates to a method of providing an individual with improved non-prescription reading glasses without the need for a diagnosis or prescription. Thus, an individual in need of reading glasses can obtain several advantages with the ability to purchase such a solution without requiring a diagnosis or prescription.

The method of the present invention thus includes the step of providing an individual with eyeglasses 10 which are produced without requiring a prescription, wherein said eyeglasses 10 comprise frames 15 having two lenses 20 therein, and each of the lenses 20 has a de-centered region 25 of increased convexity, wherein the de-centered region 25 results in increased magnification. As above, the transition between the region 25 and the peripheral regions 30 is preferably smooth an continuous. Furthermore, the wedge shape as discussed above is ideally provided.

The individual is a general consumer not having a diagnosis or prescription for eyeglasses. Thus, the individual is provided with the above discussed advantages without requiring diagnosis or prescription.

While specific embodiments have been illustrated and described, numerous modifications come to mind without significantly departing from the spirit of the invention and the scope of protection is limited by the scope of the accompanying claims.

What is claimed is:

1. Improved reading eyeglasses comprising:
frames having two lenses therein,
each of said lenses having less magnification in an upper meridian than a lower meridian and having optical centers located upward and inward from a center point of said lenses.

2. The improved reading eyeglasses according to claim 1, wherein a contour of said lenses comprises a smooth transition between a top region and a bottom region of said lenses such that there is a continuous transition in vision from said top region to said bottom region.

3. The improved reading eyeglasses according to claim 2, wherein said de-centered region is centered below a horizontal center line on said lenses, such that vision through a lower portion of said lenses through said de-centered region incorporates a magnification factor to assist a user in near vision reading, and wherein vision through the center and upper portions of the lenses incorporates less magnification for distant vision.

4. The improved reading eyeglasses according to claim 3, wherein said eyeglasses are non-prescription reading glasses.

5. The improved reading eyeglasses according to claim 1, wherein said lenses conform to a wedge shape oriented such that a thicker portion of said lenses is disposed at the inner side of said lenses and a thinner portion of said lenses is disposed at the outside portion of said lenses.

6. The improved reading eyeglasses according to claim 5, wherein said wedge shape causes light to converge inward to enable the user to focus on near objects with less strain.

7. The improved reading eyeglasses according to claim 6, wherein the contour of said lenses comprises a smooth transition between said top region to said bottom region of said lenses such that there is a continuous transition in vision from said top region to said bottom region.

8. The improved reading eyeglasses according to claim 7, wherein said de-centered region is centered above a horizontal center line on said lenses, such that vision through a lower portion of said lenses incorporates a magnification factor to assist a user in near vision reading, and wherein vision through the center and upper portions of the lenses incorporates less magnification for distant vision.

9. The improved reading eyeglasses according to claim 8, wherein said eyeglasses are non-prescription reading glasses.

10. A method of providing an individual with improved non-prescription reading glasses without the need for a diagnosis or prescription comprising the steps of:
providing an individual with eyeglasses which are produced without requiring a prescription, wherein said eyeglasses comprise frames having two lenses therein,
each of said lenses having less magnification in an upper meridian than a lower meridian and having optical centers located upward and inward from a center point of said lenses.

11. The method of providing an individual with improved non-prescription reading glasses according to claim 10, wherein the contour of said lenses comprises a smooth transition between a top region and a bottom region of said lenses such that there is a continuous transition in vision from said top region to said bottom region.

12. The method of providing an individual with improved non-prescription reading glasses according to claim 11, wherein vision through a lower portion of said lenses incorporates a magnification factor to assist a user in near vision reading, and wherein vision through the center and upper portions of the lenses incorporates less magnification for distant vision.

13. The method of providing an individual with improved non-prescription reading glasses according to claim 10, wherein said lenses conform to a wedge shape oriented such that a thicker portion of said lenses is disposed at the inner side of said lenses and a thinner portion of said lenses is disposed at the outside portion of said lenses.

14. The method of providing an individual with improved non-prescription reading glasses according to claim 13, wherein said wedge shape causes light to converge inward to enable the user to focus on near objects with less strain.

15. The method of providing an individual with improved non-prescription reading glasses according to claim 14, wherein the contour of said lenses comprises a smooth transition between said top region and said bottom region of said lenses such that there is a continuous transition in vision from said top region to said bottom region.

16. The method of providing an individual with improved non-prescription reading glasses according to claim 15, wherein vision through a lower portion of said lenses through said de-centered region incorporates a magnification factor to assist a user in near vision reading, and wherein vision through the center and upper portions of the lenses incorporates less magnification for distant vision.

17. The method of providing an individual with improved non-prescription reading glasses according to claim 16, wherein the individual is a general consumer not having a diagnosis or prescription for eyeglasses.
